(19) United States
(12) Patent Application Publication
(10) Pub. No.: US 2006/0187080 A1
(43) Pub. Date: Aug. 24, 2006

(54) Software updates for electronic appliances

(76) Inventor: David Neil Slatter, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/342,864

(22) Filed: Jan. 31, 2006

(30) Foreign Application Priority Data
Jan. 31, 2005 (GB) 0501889.0

(51) Int. Cl. H04Q 5/22; G05B 19/02

(52) U.S. Cl. 340/825.22; 340/10.51; 340/10.4

(57) ABSTRACT

A method of updating software on an appliance that includes an interrogator for interrogating memory tags includes releasably attaching a memory tag to the appliance, updating the software from the memory tag, and removing the tag from the appliance. The update software can be supplied on a memory tag attached to a carrier having information thereon relating to the update software.

### RELATED APPLICATIONS

The present application is based on, and claims priority from, GB Application Number 0501889.0, filed Jan. 31, 2005, the disclosure of which is hereby incorporated by reference herein in its entirety.

### FIELD OF THE INVENTION

The present invention relates to the updating of software on electronic appliances, and is particularly applicable to firmware updates in relatively low cost appliances such as mobile phones, personal digital assistants (PDAs) and digital cameras.

### BACKGROUND TO THE INVENTION

With many electronic appliances, functionality is frequently upgraded, and a process is needed to ensure that each appliance that is manufactured is updated, often before it is even used, or when it is first used, as well as later in the life of the appliance. For many appliances, particularly smaller appliances, the programs that determine the functionality are stored as firmware. In this case the firmware needs to be updated to upgrade the functionality. This may require updating during the manufacturing process, or after the manufacturing process, for example when the appliance is first used. Firmware changes made after pre-programmed components have been put onto printed circuit boards generally require a high bandwidth error free channel to transfer the data from the stored form of the upgrade into the device memory. Also it is desirable to make the upgrading process as simple as possible for the user to avoid human errors during upgrading.

It is known to download firmware from the internet using a PC and then to upload it onto an appliance, such as a mobile phone, over its serial digital port. However, this requires the user to be able to operate the PC to perform the upgrade, and the serial port is usually slow. It is also known to upgrade mobile phones over the air, i.e. over the mobile phone network. However this also tends to be slow.

It has also been proposed, in US2002140966A1 to provide upgrades for printing systems via an RFID tag attached to a replacement printer cartridge. However, this is only possible because replacement printer cartridges are required on a regular basis.

### SUMMARY OF THE INVENTION

The present invention provides a method of updating software on an appliance that includes an interrogator for interrogating memory tags, the method comprising releasably attaching a memory tag to the appliance, updating the software from the memory tag, and removing the tag from the appliance.

The present invention further provides an appliance having a memory tag releasably attached to it, the appliance including memory having software stored therein, and a reading device arranged to read data from the tag, wherein the tag has a software update stored thereon.

The present invention still further provides a method of manufacturing an appliance comprising providing an appliance with software loaded thereon, releasably attaching a memory tag to the appliance, and loading a software update onto the tag, the software update being arranged for updating the software.

The present invention still further provides apparatus for updating software on an appliance, the apparatus comprising a memory tag having upgrade software stored thereon and being arranged to communicate the software wirelessly to a reader, and a carrier to which the tag is attached, the carrier carrying information relating to the upgrade software. Corresponding methods of distributing software updates and of updating software are also provided.

### BRIEF DESCRIPTION OF THE DRAWINGS

Preferred embodiments of the present invention will now be described by way of example only with reference to the accompanying drawings.

FIG. 1 is a schematic view of an appliance according to an embodiment of the invention;

FIG. 2 is a schematic view of a document for use with the appliance of FIG. 1, having a memory tag on it;

FIG. 3 is a schematic diagram of a memory tag for use with the appliance of FIG. 1;

FIG. 4 is a circuit diagram of a memory tag and an interrogator forming part of the appliance of FIG. 1;

FIG. 5 is a schematic view of the memory tag of FIG. 4 attached to the appliance of FIG. 1;

FIG. 6 is a flow diagram illustrating the process of updating firmware on the appliance of FIG. 1;

FIG. 7 is a schematic diagram showing a memory tag for use in a method according to a further embodiment of the invention;

FIG. 8 is a schematic view of an appliance according to a further embodiment of the invention; and

FIG. 9 is a schematic view of a software updating pack according to a further embodiment of the invention.

### DETAILED DESCRIPTION OF THE PREFERRED EMBODIMENTS

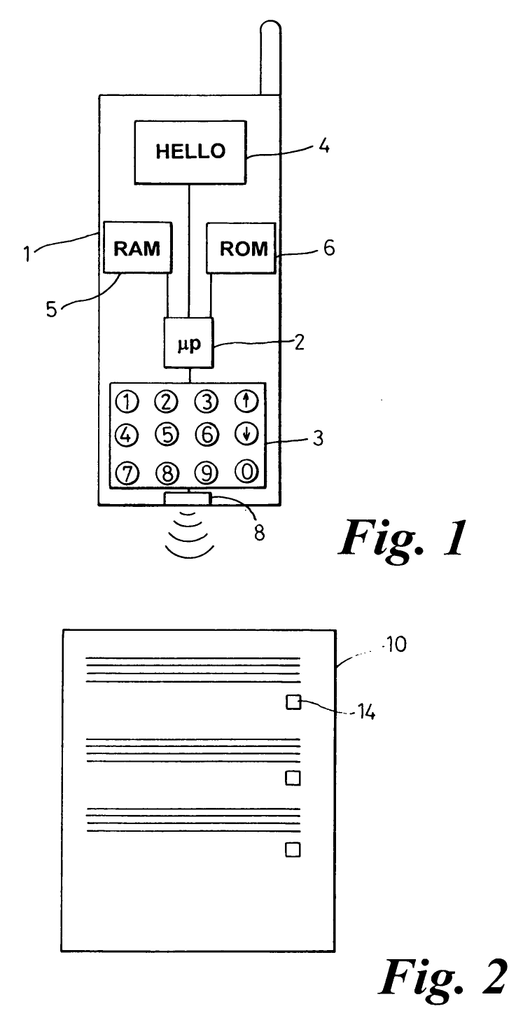

Referring to FIG. 1 an electronic appliance in the form of a mobile phone 1 comprises processor 2, a user input in the form of a keypad 3 and a display screen 4. It also comprises a first memory 5 having software stored in it, and second memory 6 which is a read-only memory (ROM) having firmware stored in it. The firmware includes, for example, applications that determine the functionality of the phone. The software in the memory 5 includes, for example, games and other non-essential software that can be deleted or replaced by the user.

The phone further includes a radio frequency (RF) interrogator 8 arranged to read data wirelessly from a memory tag operating at radio frequencies and upload data from it as will be described in more detail below. The interrogator 8 in this embodiment can also transmit data wirelessly to a memory tag, but in some cases an interrogator that can only read data could be used.

Referring to FIG. 2, a typical document 10 for use with the phone 1 of FIG. 1 has a number of memory tags 14 embedded in it. The data on each of the tags 14 is relevant to the content 16 of the document 10 which it is located adjacent to. Each tag 14 includes an RF transponder circuit and memory in which data is stored. During normal use of the interrogator 8, the interrogator is held close to one of the tags 14 and wireless interrogation is triggered using one of the input buttons on the keypad 3. The interrogator 8 uploads data from the tag 14 and stores it in RAM 5.

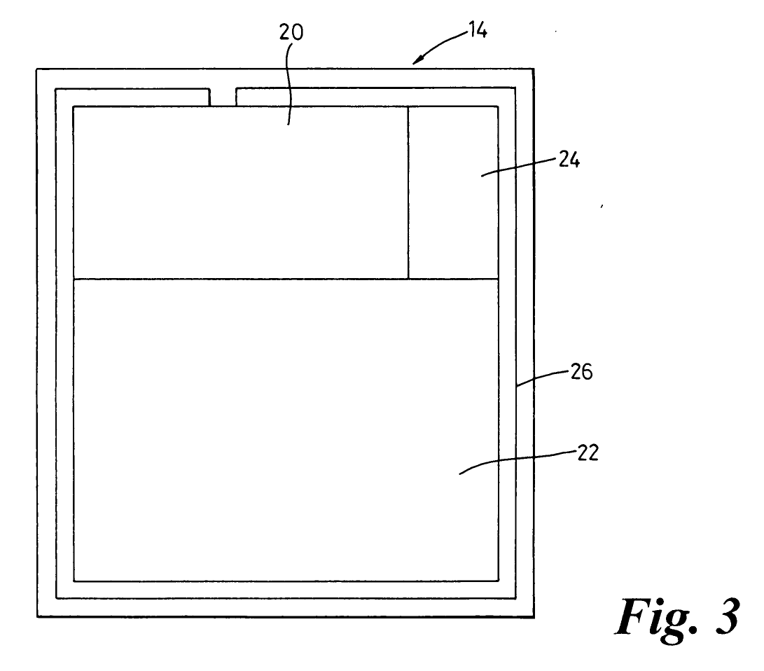

Referring now to FIG. 3, a schematic of one of the memory tags 14 is shown. The memory tag 14 is a memory tag provided on a chip, and comprises an RF transponder circuit 20, a memory 22, a power supply capacitor 24 and an antenna coil 26 having only a few turns e.g. five, or as in this case a single turn. The RF transponder circuit 20 operates at 2.45 GHz, is of an area of approximately 0.5 mm², and will be described further below. The memory 22 provides 1 Mbit of capacity of non-volatile memory and is of an area of approximately 1 mm², and uses FRAM (ferroelectric random access memory) or MRAM (magnetoresistive random access memory) or similar memory technology requiring low power. The memory tags 14 are of a substantially square shape in plan view with an external dimension D for their sides of around 1 mm.

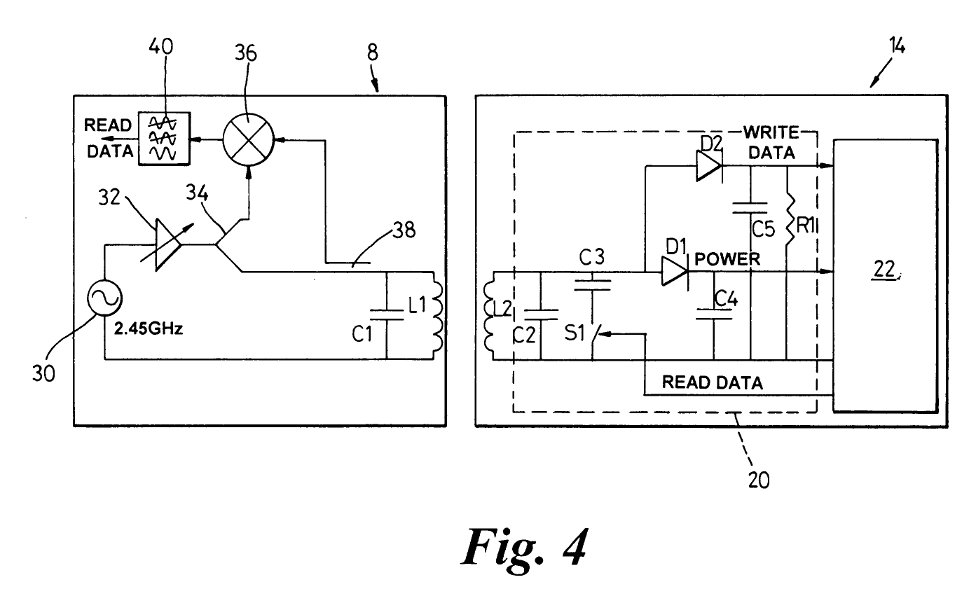

Referring now to FIG. 4, the circuitry of a memory tag 14 and circuitry of the interrogator 8 are illustrated schematically, using conventional component identifications (C-capacitor, L-inductance, R-resistor, D-diode and S-switch). The RF transponder circuit 20 of the memory tag 14 comprises a capacitor C2 which, in combination with the antenna coil L2 (26), forms a resonant circuit with component values being chosen to tune the combination to approximately 2.45 GHz for inductive coupling with the interrogator 8. The portion of transponder circuit 20 responsible for power supply is diode D1 and capacitor C4 (24), with diode D1 rectifying the alternating current generated by the inductive coupling and the capacitor C4 acts as a power supply storage. The portion of the transponder circuit 20 responsible for receiving transmitted data from the interrogator 8 is diode D2 capacitor C5 and resistor R1 which form a simple envelope detector; the data thus received is stored in memory 22. The portion of the transponder circuit 20 responsible for the reading of data from the memory 22 is the tuned circuit L2/C2 in combination with S1 and C3, switching C3 in and out of the circuit using S1 changes the resonance of tuned circuit L2/C2 resulting in phase modulation of the reflected power from the memory tag 14 to the phone 1.

The circuit 28 of the interrogator 8 comprises a signal generator 30 which generates a signal at the chosen frequency of 2.45 GHz. This signal passes via an amplitude modulator 32, where it is amplitude modulated with data to be written to the memory tag 14, and a splitter 34, to an antenna L1 and capacitor C1 which form a tuned circuit. The component values of L1 and C1 being chosen to tune it to 2.45 GHz, as for the tuned circuit in the memory tag 14, in order to maximise inductive coupling between the two circuits, and thus transmission of power and data to the memory tag 14.

The splitter 34 takes a part (as much as 50% of the power) of the amplitude modulated signal, for use as a reference signal, and passes it to a multiplier 36. The signal received from the memory tag 14, via the tuned circuit L1/C1 and divided from the outgoing signal by a coupler 38, is also passed to the multiplier 36. Thus the transmitted amplitude modulated signal and received signal are multiplied and then pass through a low pass filter 40 to provide a signal comprising the phase modulation from the memory tag 14 and thus indicative of the data read from the memory tag 14.

One amplitude modulation format which may be used to apply the data to be transmitted to the 2.45 GHz signal is Amplitude Shift Keying (ASK) which only requires the simple envelope detector D2/C5 described in the circuit 20. However, other amplitude modulation formats may also be employed. Further alternatives are Frequency Shift Keying (FSK) and Phase Shift Keying (PSK) that provide near constant envelope modulation, that is without any significant amplitude modulation, however these options have more complex demodulation requirements and thus demand more complex circuitry in the memory tag 14.

With the apparatus of memory tag 14 and interrogator 8 described above power transfer of around 25% can be achieved with a distance of around 1.8 mm between the antennae L1 and L2, of the interrogator 8 and memory tag 14 respectively. This is sufficient to transfer enough power to the memory tag 14 for it to operate.

Referring to FIG. 5, during production of the mobile phone 1, a memory tag 14a is releasably attached to the phone 1 in close proximity to the interrogator 8. This is achieved by encapsulating the tag 14a in a coating 42 of electrically non-conductive plastics material and adhering it to the casing 44 of the phone using a releasable adhesive. Also during production of the phone, the ROM 6 of the phone 1 has a number of programs loaded onto it that provide the functionality of the phone, and which include an update control program. The programs can be loaded onto the ROM either before or after the ROM is installed in the phone 1. The update control program is arranged to control the writing of updates and other data to the ROM 6. It is also arranged to have access to data relating to the firmware stored in the ROM and in particular to data identifying the programs stored in the ROM and their update status. This enables it to determine whether a particular upgrade is appropriate for the phone 1 at any particular time. These programs may, for example, be pre-programmed into a chip before it is attached to a printed circuit board that forms part of the phone 1.

At another point in the production of the phone 1, a software upgrade is uploaded onto the memory tag 14a using a further read/write device 46. This is essentially the same as the interrogator 8 in the phone 1, and is arranged to transmit a firmware upgrade to the memory tag 14a using RF transmission. The upgrade includes a reference or identity code that is unique to that upgrade. In this case this step is carried out at the end of the production process. This enables the most up-to-date upgrade to be uploaded to the memory tag 14a just before it leaves the factory. It will also be appreciated that uploading the upgrade to the tag 14a enables the upgrade to be provided to the phone 1 without having to power up the phone.

The phone is then shipped to a distributor, and distributed to one of a number of retail outlets where it is sold to a user. When the user first switches on the phone 1 to power it up, he is instructed to input a predetermined command to the phone using the keypad 3, and this input is recognised by the update control program which is arranged to control the interrogator 8 on the phone 1 to interrogate the tag 14a and upload the update from it. The update control program checks the reference code associated with the update to determine whether the update is appropriate for the firmware currently on the phone. If it is, the update control program controls the storing of the upgrade in the ROM 6 of the phone 1 thereby updating the firmware, and hence the functionality of the phone 1.

When the update is complete the update control program is arranged to produce an output to the user, on the screen 4, to indicate this, and the user then removes the tag 14a from the phone 1, together with its coating 42. This uncovers the interrogator 8 so that it can be used in the normal manner as a read/write device to read data from, and write data to, other memory tags.

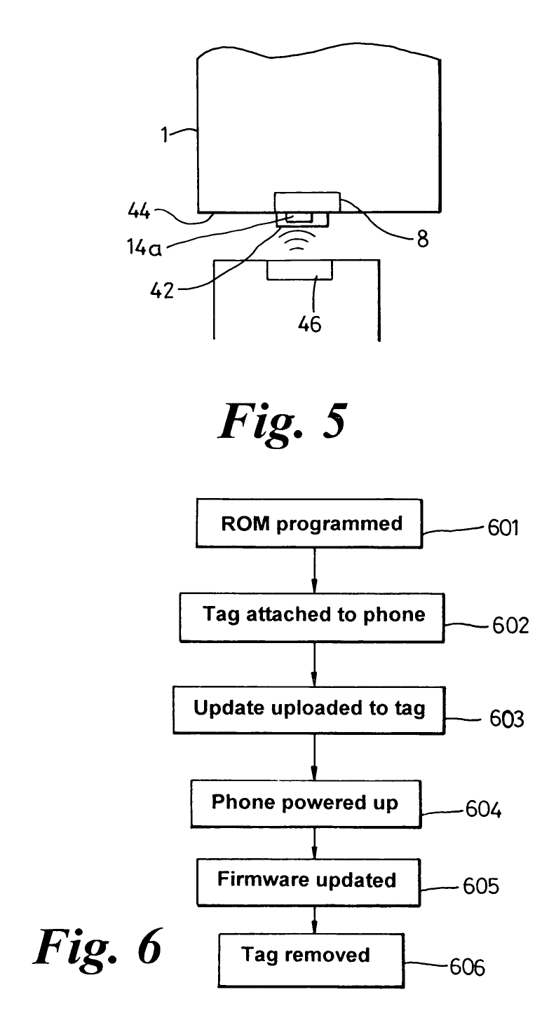

The above process is illustrated in FIG. 6, in which the pre-programming of the ROM 6 is the first step 601, attachment of the memory tag 14a to the phone 1 is the second step 602, the uploading of the update to the memory tag 14a is the third step 603, powering up of the phone 1 for the first time is the fourth step 604, updating of the firmware on the phone 1 is the fifth step 605 and removal of the memory tag 14a is the sixth step 606. However, it will be appreciated that the order of these steps can be varied in a number of ways. For example, the update can be uploaded to the memory tag 14a before the tag is attached to the phone 1. The memory tag 14a can be attached to the phone 1, or at least to a part of the phone such as its casing, before the ROM chip is inserted in the phone 1. Alternatively the memory tag may be shipped to the user or to a retailer separately from the phone, and an appropriate firmware version can then be attached to the phone by a retailer at the point of sale of the phone, or (where shipped to the user) by the user prior to performing the firmware update.

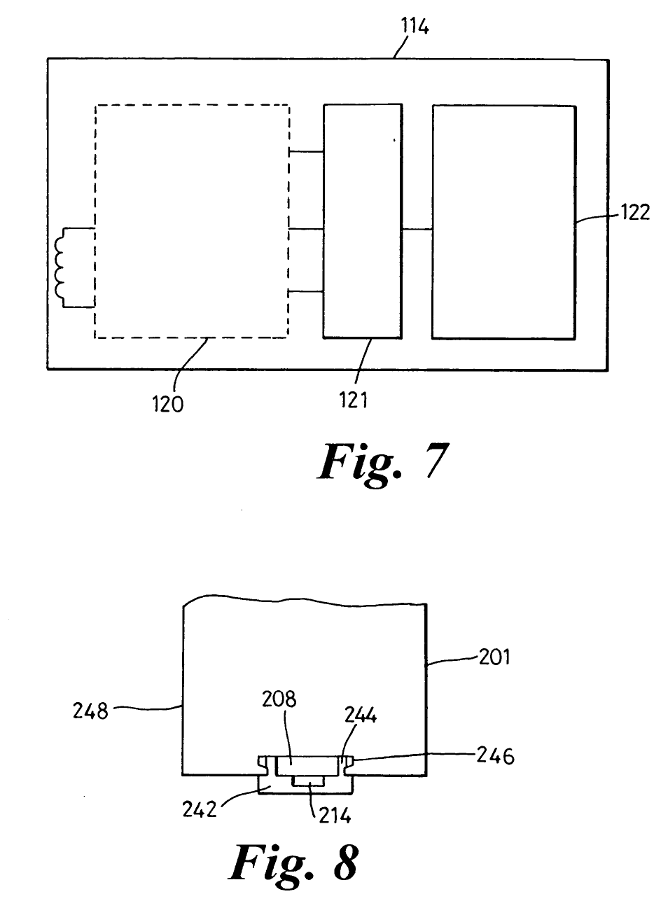

Referring to FIG. 7, in a second embodiment of the invention, the memory tag 114 includes a processor 121 as well as a memory 122 and transponder circuit 120, and the memory 122 has a number of upgrades stored in it. In this case, when the update is initiated by the user, the update control program transmits via the phone's RF interrogator 8 an update command to the memory tag 114, which responds by transmitting an interrogation command to the phone 1. The update control program on the phone responds to this by transmitting data back to the tag 114 identifying the status of the firmware on the phone, for example identifying the programs stored on it and their update status. When it receives this data, the processor 121 on the memory tag 114 determines which of the updates is appropriate to the phone, selects one or more of those updates, and transmits them to the phone 1, together with ID references. The update control program then updates the firmware stored on the ROM of the phone.

Referring to FIG. 8 a mobile phone 201 according to a further embodiment of the invention has an RF interrogator or read/write device 208 mounted in it in the same way as the first embodiment. However, at either side of the interrogator 8 the housing 248 of the phone has a recess 246 formed in it. An memory tag 214 is embedded in a plastic clip 242 that has a pair of resilient legs 244 which are arranged to fit into the recesses 246 in the phone housing. This arrangement can be used in the same way as the embodiment of FIG. 5. Alternatively, the memory tag 214 can be supplied to the user with the phone, but not actually attached to it, and the user can attach the tag 214 to the phone temporarily using the clip 242, perform the upgrade as in the embodiment of FIG. 5, and then remove the tag again so that the phone 201 can be used as normal.

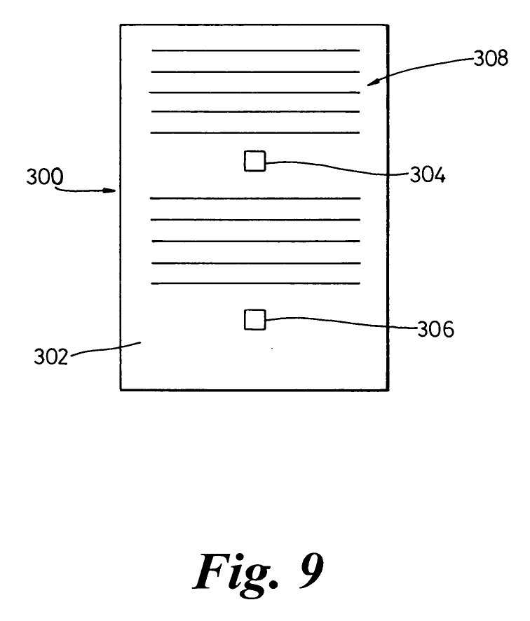

Referring to FIG. 9, the mobile phone 1 can be further updated after it has been initially powered up and used, using a firmware update pack 300. This pack comprises a carrier, in this case a sheet of paper 302, with two memory tags 304, 306 embedded in it. Each of these memory tags 304 306 has stored in it a different firmware update, and associated with each tag 304, 306 is printed human readable information 308 relating to the respective update, including the application that the update relates to, the type of phone that it is suitable for, the version of the update, and the version of the application that the phone must have already stored on it in order for the update to be effective.

The update pack 300 may be issued, for example, to all users of a phone running a particular application as soon as an update to the application is available. This can be achieved provided there is a database identifying users and their addresses to which the upgrade pack should be sent, or at least a contact address to which an offer can be sent, which may be a postal address of an email address. Provided such a database does exist, then the supplier of the application only needs to identify from the database those customers or users for whom the update is appropriate and send the update pack 300 to each of them. Alternatively, once the appropriate customers have been identified, they can be offered the update, either free or for payment of a predetermined price, and supplied with the update pack only once they have paid, or agreed to pay, for it. A further possibility is for the update pack to be offered to customers as a general offer, for example from an advertisement for the update, or by means of an email sent to each customer. In this case the customers need to identify that the update is available and suitable for them, and then purchase the update from the supplier of the update, for example by making payment and identifying the update that they require.

When the user has obtained the update pack, they first check the information 308 provided on the carrier 302 to identify whether the memory tag 304 or the memory tag 306 carries an upgrade that is suitable for their phone. When they have identified a tag, for example tag 304, with a suitable upgrade stored on it, the phone 1 is held over the carrier 302 so that the interrogator 8 is close to the appropriate tag 304. Then in order to initiate the update, the user inputs an update command to the phone 1 using the keypad 3. The update control program on the phone is arranged to recognise this command, and respond by initiating the update process. It does this by controlling the interrogator 8 to interrogate the tag 304, and storing the update software that is received in response from the tag 304, in memory. This update process can be carried out with the tag 304 acting in a passive manner, as described above in relation to FIG. 3, or a more active manner as described above with reference to FIG. 7.

The memory tags 14 have an external dimension D around 1 mm, as described above, and the interrogator 8 is arranged to communicate with them only over a relatively short range, in this example of approximately 2D, i.e. when the interrogator 8 is in close proximity with the memory tag 14. This is because the interrogator 8 and memory tag 14 are arranged to communicate via near-field inductive interaction. However, the distance over which the interrogator 8 and memory tag 14 will communicate effectively will clearly vary with the exact details of their construction, and it may therefore be up to 10D i.e. 10 mm. Distances greater than this would limit the ability to use a plurality of memory tags 14 on a single sheet of paper 10, or other item, due to the distances which would be necessary between the memory tags 14 to ensure that the interrogator 8 does communicate with the desired memory tag 14 out of a number present. To ensure that communication is with the correct memory tag 14 in every circumstance a communication distance of 5D or less is preferable. This supports a natural and robust user interaction where the user finds the labelling text appropriate to his situation and places the reader probe on a tag collocated with the label. Only the proximate tag is energised and thus the appropriate software update is loaded. In practice hundreds of tags could be affixed to an A4 sheet of paper with no danger of unwanted interaction.

The memory tags 14 will preferably have a data rate of 10 Mbits s, which is two orders of magnitude faster than is typical in prior art devices. Such data rate would enable the interrogator 8 to be held over the memory tag for a very short period of time (“brush and go”) for the data to be read or written as appropriate.

Although the memory tags 14 described above operate at 2.45 GHz it should be understood that memory tags operating at other frequencies may be used to implement the invention. Factors affecting the choice of operating frequency for the memory tags are: a) government regulations concerning radio frequency transmissions; b) adequate bandwidth (consistent with government regulations); c) frequency high enough to render the physical size of components in the memory tag small enough to keep the area of silicon required low (and hence the cost to manufacture low); d) frequency low enough to provide adequate performance when using low-cost high-volume CMOS technology to manufacture memory tag.

While in the embodiments just described the carrier on which the memory tags are embedded are sheets of paper, it will be appreciated that other materials are also suitable. For example, sheets of other material such as plastics can be used. These have the advantage that the information relating to the updates can easily be applied to the carrier, for example by printing.

While all of the embodiments described above relate to mobile phones, it will be appreciated that the invention is also applicable to other electronic appliances, such as digital cameras and PDAs.

1. A method of updating software on an appliance that includes an interrogator for interrogating memory tags, the method comprising releasably attaching a memory tag to the appliance, updating the software from the memory tag, and removing the tag from the appliance.

2. A method according to claim 1 wherein the upgrade is written to the memory tag after said attaching.

3. A method according to claim 1 wherein the memory tag has stored thereon a trigger arranged to be recognised by the appliance and to trigger the updating.

4. A method according to claim 1 wherein the updating is carried out when the appliance is first switched on.

5. A method according to claim 1 wherein the appliance triggers the update.

6. A method according to claim 1 wherein the memory tag is attached to the appliance during manufacture of the appliance.

7. A method according to claim 1 wherein the memory tag is attached to the appliance by means of adhesive.

8. A method according to claim 1 wherein the software is firmware.

9. An appliance having a memory tag releasably attached thereto, the appliance including memory having software stored therein, and a reading device arranged to read data from the tag, wherein the tag has a software update stored thereon.

10. An appliance according to claim 9 wherein the software includes update control software arranged to control updating of the software from the tag.

11. An appliance according to claim 9 wherein the tag includes a processor arranged to control, at least partially, the updating of the software.

12. An appliance according to claim 11 wherein the processor is arranged to obtain details of the software on the appliance and determine whether the update on the tag is appropriate for that software.

13. An appliance according to claim 9 wherein the tag is attached to the exterior of the appliance.

14. An appliance according to claim 9 wherein the tag is attached to the appliance by means of adhesive.

15. A method of manufacturing an appliance comprising providing an appliance with software loaded thereon, releasably attaching a memory tag to the appliance, and loading a software update onto the tag, the software update being arranged for updating the software.

16. A method according to claim 15 wherein the software is loaded onto a memory device before the memory device is incorporated into the appliance.

17. A method according to claim 15 wherein the software update is loaded onto the tag after the tag is attached to the appliance.

18. A method according to claim 15 wherein the software update is loaded onto the tag before the tag is attached to the appliance.

19. Apparatus for updating software on an appliance, the apparatus comprising a memory tag having upgrade software stored thereon and being arranged to communicate the software wirelessly to a reader, and a carrier to which the tag is attached, the carrier carrying information relating to the upgrade software.

20. Apparatus according to claim 19 wherein the information is carried on the carrier in human readable form.

21. Apparatus according to claim 19 wherein the carrier has a plurality of memory tags attached thereto.

22. Apparatus according to claim 21 wherein the information is arranged to distinguish between the tags.

23. Apparatus according to claim 19 wherein tag is arranged to communicate with the reader via inductive interaction.

24. A method of distributing update software for appliances, the method comprising loading update software onto a memory tag, attaching the tag to a carrier, the carrier carrying information relating to the software, and distributing the tag with the carrier.

25. A method of updating software on an appliance that includes an interrogator for interrogating memory tags, the method comprising identifying from information carried on a carrier a memory tag attached to the carrier having update software stored thereon that is appropriate to the appliance, and causing the appliance to upload the software from the tag thereby to update software of said appliance.
